(19) United States
(12) Patent Application Publication
(10) Pub. No.: US 2013/0246125 A1
(43) Pub. Date: Sep. 19, 2013

(54) Service Provider Analytics

(71) Applicant: VISA U.S.A, INC., San Francisco, CA (US)

(72) Inventors: Laura DiGioacchino, San Mateo, CA (US); Jeffrey Rolland Olives, Danville, CA (US); Kevin Akerman, Orinda, CA (US); Kevin Considine, Lafayette, CA (US); Charles Byce, Mill Valley, CA (US); James VonDerheide, La Canada, CA (US)

(21) Appl. No.: 13/840,169

(22) Filed: Mar. 15, 2013

Related U.S. Application Data
(60) Provisional application No. 61/611,486, filed on Mar. 15, 2012.
(60) Provisional application No. 61/619,221, filed on Apr. 2, 2012.

(51) Int. Cl. G06Q 30/02

(52) U.S. Cl. CPC G06Q 30/0201
USPC 705/7.33

(57) ABSTRACT

A system, apparatus, computer readable media, and method are disclosed for generating analytics on customers of service provider merchants. In an example, a transaction record associated with an account identifier of a customer that purchased a first service from a first merchant may be processed and a service date for the first service may be determined. Other transaction records comprising the account identifier and that satisfy a temporal filter may be identified. Each of the other transaction records may include transaction data associated with at least one of: (1) purchase of another service to be provided within a first predetermined amount of time of the service date, and (2) purchase of a product within a second predetermined amount of time of the service date. A spending profile including information on the first service, the service date, and the transaction data for each of the other transaction records may be generated.

### CROSS REFERENCE TO RELATED APPLICATIONS

This application claims the benefit of, and priority to, U.S. Provisional Application No. 61/611,486 titled “Travel Industry Analytics Apparatuses, Methods And Systems,” filed Mar. 15, 2012, and U.S. Provisional Application No. 61/619,221, titled “Travel And Tourism Industry Analytics Apparatuses, Methods And Systems,” filed Apr. 2, 2012. The content of each of which is hereby incorporated by reference in its entirety.

### BACKGROUND OF THE INVENTION

1. Field of the Invention

The invention relates to service provider analytics. Among other fields and applications, the invention has utility in identifying other products and services purchased in conjunction with the purchase of a service from a service provider merchant.

2. Description of Related Art

Millions of transactions occur daily through the use of payment cards, such as credit cards, debit cards, prepaid cards, etc. Corresponding records of the transactions are recorded in databases for settlement and financial recordkeeping (e.g., to meet the requirements of government regulations). Such data can be mined and analyzed for trends, statistics, and other analyses. Sometimes such data are mined for specific advertising goals, such as to provide targeted offers to account holders, as described in PCT Pub. No. WO 2008/067543 A2, published on Jun. 5, 2008, entitled “Techniques for Target Offers.”

When a payment card is tendered as payment, communications are passed from a point of sale terminal over a payment network to authorize payment. The authorization process creates transaction data for the requested transaction. Merchants, however, lack tools to analyze this data to learn about their customers and performance relative to their competitors. Moreover, merchants may have misconceptions about their customers and may make business decisions that detrimentally affect their financial position. Therefore, a need exists for providing tools to permit merchants to better understand their customer base and competitors.

### BRIEF DESCRIPTION OF THE DRAWINGS

The invention may be better understood by references to the detailed description when considered in connection with the accompanying drawings. The components in the figures are not necessarily to scale, emphasis instead being placed upon illustrating the principles of the invention. In the figures, like reference numerals designate corresponding parts throughout the different views.

FIG. 1 illustrates a block diagram of a system for generating service provider analytics in accordance with example embodiments.

FIG. 2 illustrates a block diagram of a transaction database and analysis server of FIG. 1 in accordance with example embodiments.

FIG. 3 illustrates a communication flow diagram for analytics analysis in accordance with example embodiments.

FIG. 4 illustrates a spending profile in accordance with example embodiments.

FIG. 5 illustrates an aggregate spending profile in accordance with example embodiments.

FIGS. 6 and 7 depict example aspects of a graphical user interfaces (GUI) in accordance with example embodiments.

FIG. 8 illustrates example aspects of generating service provider analytics in accordance with example embodiments.

FIG. 9 illustrates a flow chart of a method for generating service provider analytics in accordance with example embodiments.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein.

### SUMMARY

The following presents a simplified summary of the present disclosure in order to provide a basic understanding of some aspects of the disclosure. This summary is not an extensive overview of the disclosure. It is not intended to identify key or critical elements of the disclosure or to delineate the scope of the disclosure. The following summary merely presents some concepts of the disclosure in a simplified form as a prelude to the more detailed description provided below.

A system, apparatus, computer readable media, and method are disclosed for generating analytics on customers of service provider merchants. In an example, a transaction record associated with an account identifier of a customer that purchased a first service from a first merchant may be processed and a service date for the first service may be determined. Other transaction records comprising the account identifier and that satisfy a temporal filter may be identified. Each of the other transaction records may include transaction data associated with at least one of: (1) purchase of another service to be provided within a first predetermined amount of time of the service date, and (2) purchase of a product within a second predetermined amount of time of the service date. A spending profile including information on the first service, the service date, and the transaction data for each of the other transaction records may be generated.

### DETAILED DESCRIPTION

The present invention now will be described more fully with reference to the accompanying drawings, which form a part hereof, and which show, by way of illustration, specific example embodiments by which the invention may be practiced. These illustrations and example embodiments are presented with the understanding that the present disclosure is an exemplification of the principles of one or more inventions and is not intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, or devices. Accordingly, the present invention may take the form of an entirely hardware embodiment, an entirely software embodiment, or an embodiment combining software and hardware aspects. The following detailed description is, therefore, not to be taken in a limiting sense.

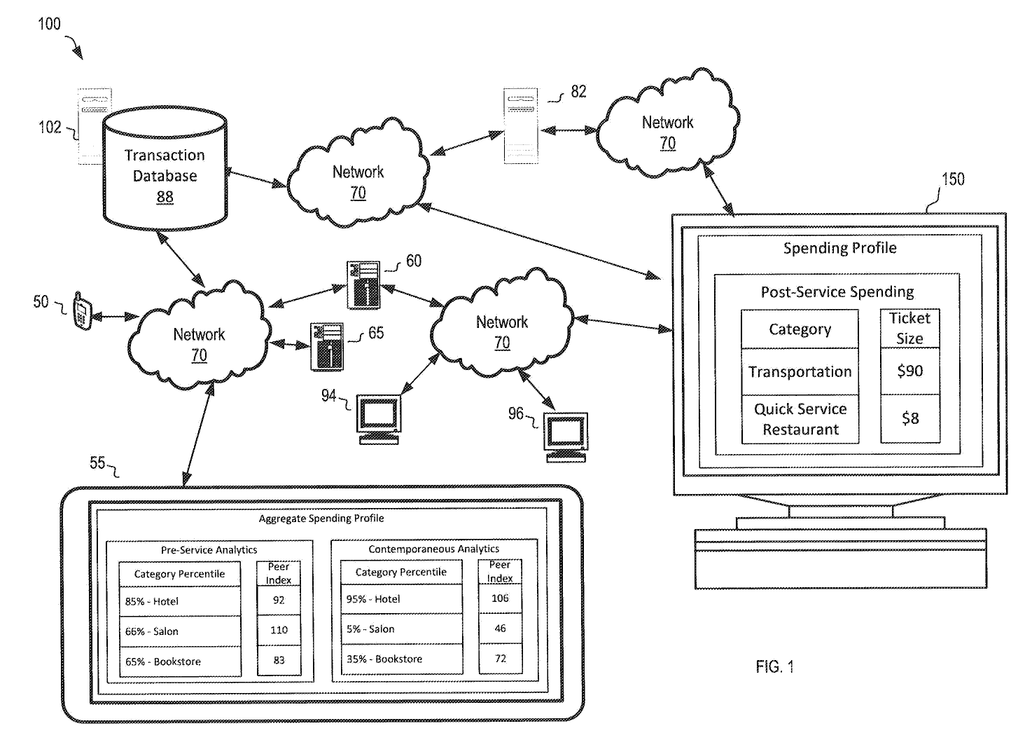

FIG. 1 illustrates a block diagram of a system 100 for generating service provider analytics in accordance with example embodiments. In some embodiments, system 100 may generate analytics data to provide service providers with insight into customer behavior, performance relative to competition, share of spend, share of travel routes, and/or the like.

In some embodiments, a credit card company may have access to a database of card-based transactions. The card-based transactions may have information on customer behavior, demand, geographical distribution, industry sector preferences, and/or the like, which may be mined to provide merchants with analytics data. In some embodiments, system 100 may receive service data from service provider merchants about purchases and/or reservations made by their customers. One type of service data may include a date when a service provider merchant is to provide a service to its customer. Based on the service data and card-based transaction data, system 100 may generate analytics data to provide merchants insights into other purchases and services obtained by their customer around the service date.

In an example, a customer may reserve a flight from an airline company and the system 100 may receive the customer's flight information from the airline company. While traveling, the customer may purchase products and/or services using a credit card or other payment account. The system 100 may aggregate transaction data of the airline's customers to determine what their customers are purchasing in the flight origination city before the flight, during the flight, and/or in the flight destination city after the flight. The system 100 may generate analytics data on customer behavior so that the airline company may better make business decisions and decisions about other merchants with which to partner.

With reference to FIG. 1, system 100 may include one or more client or merchant terminals 50 and 55, one or more e-commerce provider servers 60 and 65, one or more payment network servers 102, which may include transaction database 88, one or more merchant servers 82, one or more analysis servers 150, and one or more e-commerce provider user terminals 94 and 96. Networks 70 are shown interconnecting various components. Networks 70 may be the Internet, WAN, LAN, Wi-Fi, other computer networks (now known or invented in the future), and/or any combination of the foregoing. It should be understood by those of ordinary skill in the art having the present specification, drawings, and claims before them that networks 70 may connect the various components over any combination of wired and wireless conduits, including copper, fiber optic, microwaves, and other forms of radio frequency, electrical and/or optical communication techniques. It should also be understood that any network 70 may be connected to any other network 70 in a different manner. The interconnections between devices in system 100 are examples. Any device depicted in FIG. 1 may communicate with any other device via one or more of the networks 70.

Servers 60, 65, 82, 102, and 150 may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. Servers 60, 65, 82, 102, and 150 may be running on any one of many operating systems including, but not limited to WINDOWS, UNIX, LINUX, MAC OS, or Windows (XP, VISTA, etc.). It is contemplated, however, that any suitable operating system may be used for the present invention. Servers 60, 65, 82, 102, and 150 may be a cluster of web servers, which may each be LINUX based and supported by a load balancer that decides which of the cluster of web servers should process a request based upon the current request-load of the available server(s).

Payment network server 102 may acquire, send, process, and store information in conjunction with transaction database 88. In an example, payment network server 102 may process payment transaction requests received from a merchant terminal 55 (e.g., point of sale terminal located within a physical store where customers make purchases), an e-commerce server 60, or other device. When processing a payment transaction request, payment network server 102 may store, in transaction database 88, merchant data (e.g., data about sellers including, in some embodiments, a merchant ID), customer spend data (e.g., transactions between sellers and buyers over time), information of merchants, categories of the merchants, a date the transaction occurred (“transaction date”), a date a service is to be performed by the merchant (“service date”), and may further include geographical location categories of products and services provided by merchants. The transaction date and the service date may be the same or may differ. Merchant information associated with a transaction may also be determined using the merchant ID (which may be native to the transaction or may be derived and associated with a transaction after the transaction occurred). In some examples, a merchant may have multiple stores and a unique ID may be associated with each store (e.g., store1, store 2, etc.). Transaction database 88 may be comprised of one or more databases and may store information including and related to average income, geographic information, and other demographic data. Transaction database 88 may be provided by one or more third parties (e.g., large database providers), one or more issuers, or a combination of one or more issuers and third parties. Data may be provided on an on-demand basis or may be batch delivered to analysis server 150.

Terminals 50, 55, 94, and 96 may be general purpose computers that may have, among other elements, a microprocessor (such as from the Intel Corporation or AMD); volatile and non-volatile memory; one or more mass storage devices (i.e., a hard drive); various user input devices, such as a mouse, a keyboard, or a microphone; and a video display system. Examples of terminals include tablets, mobile phones, smart phones (e.g., iPhone), computers, laptops, and the like. In one aspect, the general-purpose computer may be controlled by the WINDOWS XP operating system. It is contemplated, however, that the present system would work equally well using a MACINTOSH computer or even another operating system such as a WINDOWS VISTA, UNIX, LINUX or a JAVA based operating system, to name a few.

Terminals 50, 55, 94, and 96 may operably connect to servers 60, 65, 82, 102, and 150, via one of many available internet browsers including, but not limited to, Microsoft's Internet Explorer, Apple's Safari, and Mozilla's Firefox. Via any of networks 70, end users may access the system 100 with an http-based website, although other graphical user interfaces can be used with the present system. Information entered by an end user via terminals 50, 55, 94, and 96 may be encrypted before transmission over a network for additional security. There are several commercially available encryption programs or algorithms available including, but not limited to, PC1 Encryption Algorithm, TrueCrypt, a Symantec encryption program, Blowfish, and Guardian Edge.

E-commerce provider servers 60 and 65 may provide a digital marketplace through which on-line merchants may provide services, offer products for sale, and provide offers and deals. In an example, e-commerce provider servers 60 and 65 may host websites that can be accessed by client or merchant terminals 50 and 55 via network 70.

Transactions occurring through client or merchant terminals 50 and 55, servers 60 and 65, payment network servers 102, merchant servers 82, e-commerce provider terminals 94 and 96, and accompanying networks 70 are portions of system 100 through which expenditures may be made for an account. Information such as type of merchant, type of purchase, type of good or service, may be collected and transferred directly or indirectly to analysis server 150 in addition to information from transaction database 88. Analysis server 150 may further query a merchant server 82 or an e-commerce server provider terminal 94 to obtain additional information about a transaction in response to receiving a payment transaction request. For example, analysis server 150 may request a service date of when a service is to be provided and a description of the service.

Analysis server 150 may be running on any one of many operating systems including, but not limited to WINDOWS, UNIX, LINUX, MAC OS, or Windows (XP, VISTA, etc.). It is contemplated, however, that any suitable operating system may be used for the present invention. Analysis server 150 may be a cluster of web servers, which may each be LINUX based and supported by a load balancer that decides which of the cluster of web servers should process a request based upon the current request-load of the available server(s).

System 100 may include additional devices and networks beyond those shown. Further, the functionality described as being performed by one device may be distributed and performed by two or more devices. Multiple devices shown in FIG. 1 may also be combined into a single device, which may perform the functionality of the combined devices. System 100 may perform analysis based on information provided to and/or obtained by analysis server 150 from a variety of sources including those depicted in FIG. 1, such as, for example, transaction database 88.

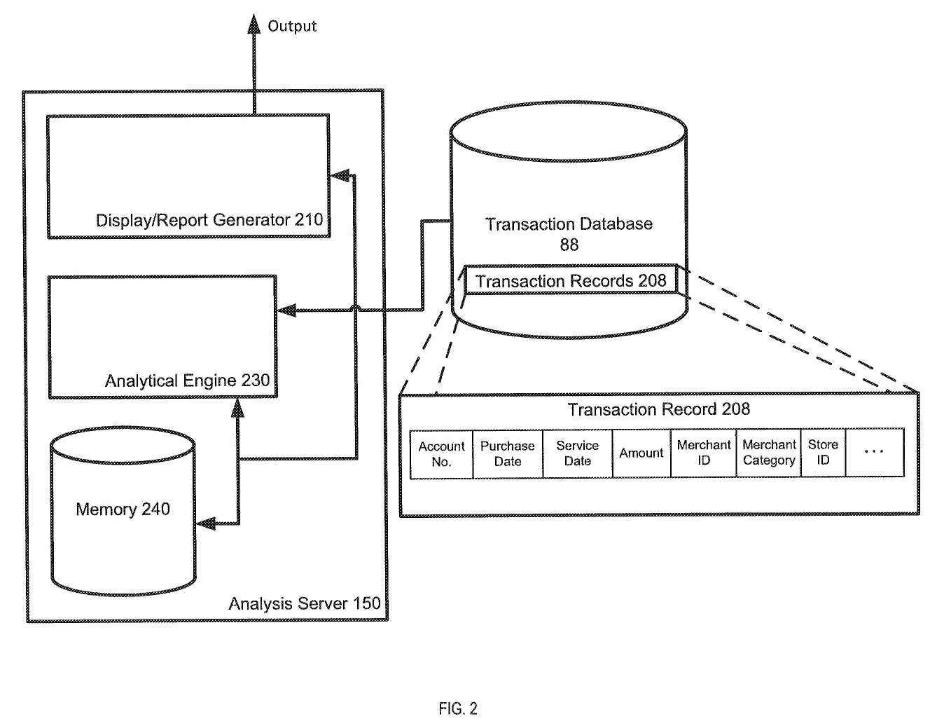

FIG. 2 illustrates a block diagram of the transaction database 88 and analysis server 150 of FIG. 1 in accordance with example embodiments. Analysis server 150 may be connected to transaction database 88 through networks 70 as illustrated in FIG. 1. Analysis server 150 includes display/report generator 210, analytical engine 230, and memory 240. Transaction database 88 may include transaction records 208.

Transaction records 208 stored in database 88 may be generated based on data acquired via networks 70 from one or more of client terminals, merchant terminals, merchant servers, and/or e-commerce services. Transaction records 208 may store transaction data that includes, for example, one or more of an account identifier of a payment account, a transaction date indicating the date of purchase, a service date indicating a date at which a service is to be provided, purchase amount, merchant data (such as a native or derived merchant ID), store ID, merchant categories, geographic information (e.g., ZIP+4 data on a payment account, a geographic location where a service is to be provided, an origination location, a destination location), and the like. Transaction records 208 may also store non-purchase data (e.g., distance traveled, where a customer also traveled, etc.). In some embodiments, transaction records may include details about the products and/or services involved in the purchase. Examples of services may include concerts, hotel accommodations, transportation (e.g., travel by air, bus, rail, car, and the like), car rentals, entertainment venues, restaurants, salon services, or any other type of service. A list of items purchased in the transaction may be recorded together with the respective purchase prices of the items and/or the respective quantities of the purchased items. The products and/or services can be identified via stock-keeping unit (SKU) numbers, or product category IDs. The purchase details may be stored in a separate database and be looked up based on an identifier of the transaction.

Transaction records 208 along with other information from transaction database 88 provide input for the analysis server 150. Analytical engine 230 is configured to execute instructions, such as instructions physically coded into the analytical engine 230, instructions stored in memory 240, instructions stored over a network 70, or from a combination of sources. Analytical engine 230 receives information from transaction database 88 and performs analysis in accordance with the subject technology. Memory 240 be comprised of one or more databases and may be physically located in analysis server 150 or connected to analysis server 150 through any network 70. Memory 240 may be volatile, non-volatile, or may incorporate both. Memory 240 may store instructions that are executed by analytical engine 230 to perform service provider analytics.

Display/report generator 210 receives information from analytical engine 230 and/or memory 240 and provides display and report information as output to any device configured to receive and/or display such information including, but not limited to, client devices, merchant terminals, and servers.

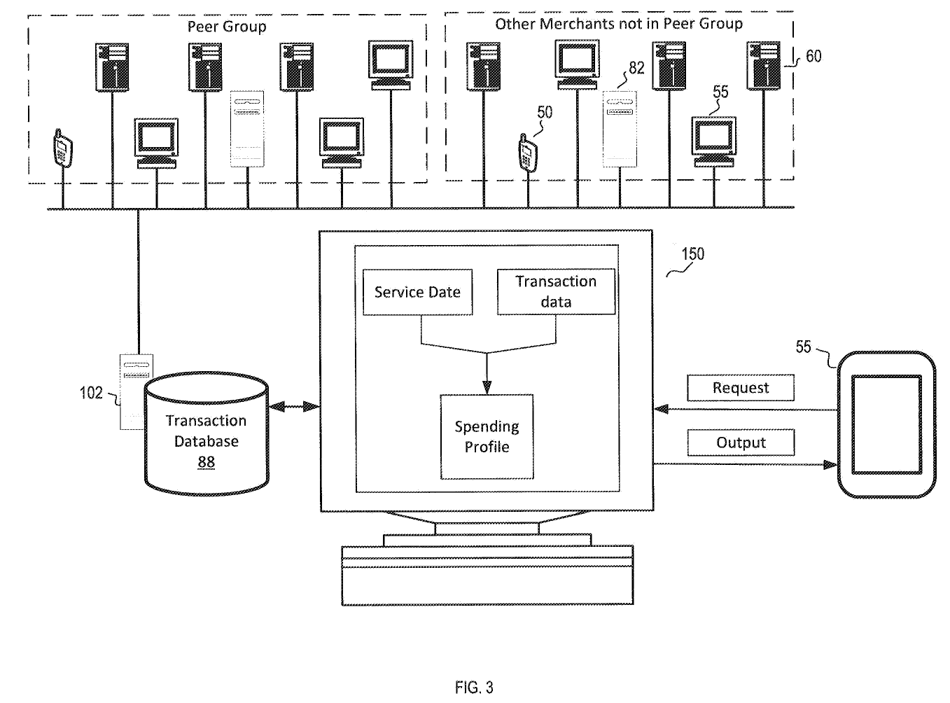

FIG. 3 illustrates a communication flow diagram for analytics analysis in accordance with example embodiments. In an example, payment network server 102 may process payment transaction requests received from a number of c-commerce servers 60, merchant terminals 55, merchant servers 82, etc., of merchants in the same and in different peer groups. Peer groups may be competitors in a particular industry, similarly sized merchants, or other groupings of businesses with sufficient traits in common. For example, FIG. 3 illustrates servers/terminals of merchants in a peer group and other servers/terminals of merchants not in the peer group. Payment network server 102 may generate transaction records 108 based on processing payment transaction requests. The number of transaction records 108 included in transaction database 88 may change over time, and analysis server 150 may frequently (e.g., periodically) query transaction database 88 for at least a portion of the transaction records 108. For example, a merchant terminal 55 may communicate a request to analysis server 150 for obtaining information on their customers' purchase behavior.

Analysis server 150 may analyze the transaction records 208 to provide analytics on what other products and services a merchant's customers are purchasing near the same time the merchant is scheduled to provide a service to the customers. For instance, an airline may want to know what other purchases their customers are making before arriving at the airport, while at the airport, during flight, at their destination, on their return flight, and after their return home. Other examples of service provider merchants include concert providers, hotels, sports teams/venues, car rental companies, recreation equipment rental companies, travel agencies, tour providers, etc. Service provider merchants may use the analytics to determine potentially desirable partnerships they should form with other merchants to market to their actual and potential customers before, during, and after the date of service or the date at which a good is provided. Service provider analytics may also be used to compare a first merchant's performance to other merchants, such as peer merchants.

In an example, analysis server 150 may create a spending profile for a customer to monitor transactions and services occurring near to a date that a particular merchant is scheduled to provide a good or service to the customer. For instance, a customer may present a payment card or may use a mobile device to purchase a service from a particular merchant (e.g., at a point of sale terminal, via a website, over the phone, etc.) that is to be provided on a particular date (e.g., on a service date). Examples of service dates may be the date of a flight, the beginning date of a hotel reservation or car rental reservation, the date of a concert or sporting event, and the like.

The merchant terminal 55 may obtain data from the card (or mobile device) including data on the customer (e.g., name) and an account identifier of the customer's payment account. For example, the account identifier may be a personal account number (PAN), a credit card number, a debit card number, or other information for identifying a payment account of a customer. The merchant terminal 55 may communicate a payment transaction request including the obtained data to the payment network server 102, which may respond to the merchant terminal 55 approving or declining the payment. If approved, the payment network server 102 may update the transaction database 88 with a transaction record 208 describing the transaction (e.g., transaction date, service date, description of service). Optionally, merchant terminal 55 or payment network server 102 may inform analysis server 150 of the approval. In some examples, analysis server 150 may periodically query transaction database 88 for transaction records 208.

In some examples, the payment transaction request may include service data providing information describing the service provided by the merchant and a service date indicating the date at which the merchant is to provide the service. The service date may be a single date or may be range of dates. In some examples, service data may be extracted from fields included in clearing interchange data messages.

Service data may be industry specific. In an airline example, service data may include one or more of an origination city, one or more destination cities (e.g., if a trip has multiple legs), and a date and optionally a time of each flight in a trip. The date of each flight may be considered a service date. In a car rental example, service data may include one or more of a car pick-up date (e.g., a service date), a geographic location at which the car is to be picked up, and a number of days that a car is reserved. In a hotel example, service data may include one or more of a scheduled check-in date (e.g., a service date), a scheduled check-out date, and a geographic location of the hotel. Instead of or in addition to including service data in the payment transaction request, analysis server 150 may also query transaction database 88 or a merchant server 82 for the service data and/or for additional service data. Service data may also include data describing the service purchased as well as other related information.

For example, analysis server 150 may request additional service data from a merchant server 82. The additional service data may be any type of data relating to a provided service. In an airline example, additional service data may include the departure airport, the destination airport, intermediate airports, the flight number(s), number of seats booked by the customer, whether the customer cancelled a previous trip, whether the customer upgraded their seat, distance traveled, and the like.

Based on knowledge of an account identifier and the service date, analysis server 150 may search for transaction records of other services obtained and/or products a merchant's customer also purchased at about the same time as the service date. For example, an airline may provide a customer with flights to and from a destination for a four day trip. The airline may be interested in what purchases their customers make before their outgoing flight, while on the airplane, while at their destination, and after their return flight. Others may be similarly interested in understanding purchases made by consumers before and after the service date, as well as the amount of time that elapsed between the transaction and service dates.

To obtain relevant transaction records, analysis server 150 may query transaction database 88 to retrieve some or all transaction records 208 having the account identifier of the merchant's customer. Analysis server 150 may also filter the retrieved transaction records based on one or more of a temporal filter, a geographic filter, and a customer attribute filter. The filter(s) may be part of the query sent to the transaction database 88 or may be performed by analysis server 150 on retrieved transaction records 208 having the account identifier.

In an example, a temporal filter may specify one or more predetermined time ranges relative to the service date. For example, the temporal filter may filter the retrieved transaction records to only include transaction records occurring before the service date, on the service date, or after the service date. The predetermined time ranges may be a particular time frame during a day (e.g., 6 AM-9 AM on the morning of the service date), a date range (e.g., 5 days before the service date, 5 days before the service date and one day after the service date), or any other desired time frame. A merchant user may specify a predetermined time range of interest or it may be a default value. Analysis server 150 may also recommend the predetermined time range based on product purchase volume or other service purchase volume. The predetermined time ranges may also differ for products and services. In an example, a predetermined amount of time may be longer for products (e.g., a range of two days before a service date and two days after a service date) than for services (e.g., a range of one day before to four hours after).

In an example, a geographic filter may filter the retrieved transaction records to only include transaction records associated with a particular geographic location or locations. Example geographic locations are airports, ports, neighborhoods, zip codes, cities, states, countries, and the like. In an airline example, geographic filters may be used to only retrieve transaction records associated with other services provided within a predetermined distance of a customer's home, a departure airport, a destination airport, or a destination city.

In an example, a customer attribute filter may filter the retrieved transaction records based on demographic information or spending patterns of a merchant's customers. Example customer attribute filters may include an income range filter, an age filter, a gender filter, education level filter, purchase history filter, and the like.

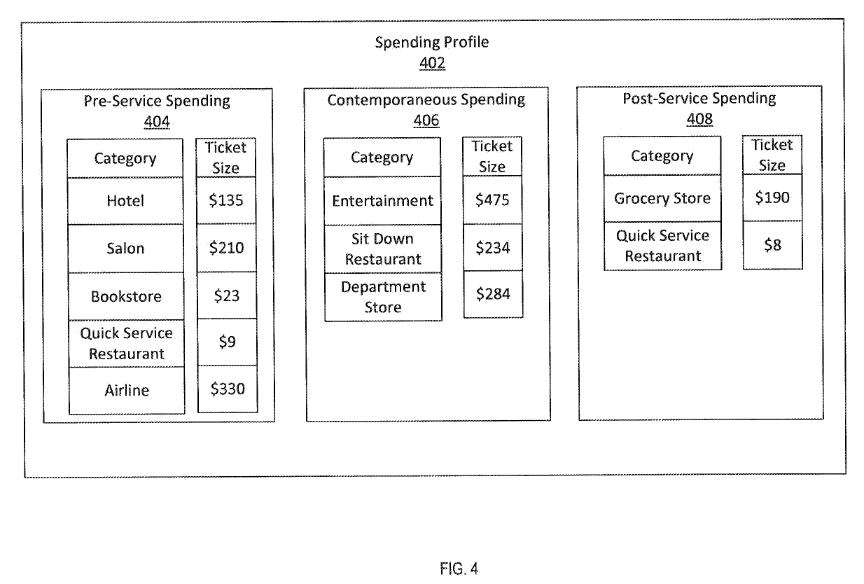

Analysis server 150 may process the retrieved transaction records to generate a spending profile. The spending profile may identify products and other services purchased from any merchant at about the same time as the service date. FIG. 4 illustrates a spending profile in accordance with example embodiments. The spending profile 402 may identify pre-service spending 404, contemporaneous spending 406, and post-service spending 408. The spending profile 402 may also categorize types of spending and identify a ticket size of each purchase.

Pre-service spending 404 may identify purchases made by a service provider merchant's customers before the service date. The pre-service spending 404 may include all purchases made on the service date prior to the time the service is scheduled to be provided. Contemporaneous spending 406 may identify purchases made by a service provider merchant's customers while the service is being provided. Post-service spending 408 may identify purchases made by a service provider merchant's customers after the service has been provided.

The following provides an example of generating a spending profile by analysis server 150 based on purchase activity of a customer of cruise line merchant. In this example, a cruise may be departing from San Francisco at 2 PM on March 15^{th} (e.g., the service date) and returning to port on March 22^{nd}. The booked cruise may have scheduled stops in San Diego and Cabo San Lucas. A temporal filter may be a time range of one week prior to the March 15^{th} departure and three days after March 22^{nd} return. There may not be any geographic filter on transaction records prior to the March 15^{th} and after March 22^{nd}. A geographic filter may include only payment transactions on products purchased and services redeemed within 40 miles of San Diego and 100 miles of Cabo San Lucas between March 15^{th} and March 22^{nd}. A customer attribute filter may also be applied in an analysis to limit data based on particular demographic information, such as women over the age of thirty with an income of at least $45,000 per year.

Analysis server 150 may query transaction database 88 using an account identifier of a customer on the cruise and one or more of the geographic, temporal, and customer attribute filters to obtain one or more transaction records 208 for generation of spending profile 402. In an example, analysis server 150 may process the transaction records 208 to identify pre-service spending 404 occurring before the cruise departs at 200 PM on March 15th, contemporaneous spending 406 occurring between after departure on March 15^{th} and the time of return on March 22^{nd}, and post-service spending 408 occurring after the time of return March 22^{nd}. For instance, before hoarding the cruise ship on March 15^{1h}, analysis server 150 process the transaction records 208 to determine that the customer flew to San Francisco on March 14, stayed at a hotel in San Francisco the night of March 14^{th}, made purchases at a salon, bookstore, and quick service restaurant, as well a ticket size of each purchase. Analysis server 150 may categorize the transaction records into categories and may generate data on pre-service spending 404 for each category and ticket size. Analysis server 150 may then populate the pre-service spending 404 portion of spending profile 402. As seen in FIG. 4, pre-service spending 404 includes categories of hotel, salon, bookstore, quick service restaurant, and airline, as well as a total ticket size indicating the amount spent in each category.

Between March 15^{th} and March 22^{nd}, analysis server 150 may process the transaction records 208 to determine that the customer purchased entertainment, had meals at ten sit down restaurants, made a purchase from a department store, as well as a ticket size of each purchase. Analysis server 150 may categorize the transaction records into categories and may generate data on contemporaneous spending 406 for each category and ticket size. As seen in FIG. 4, contemporaneous service spending 406 includes categories of entertainment, sit down restaurant, and department store, as well as a total ticket size indicating the amount spend in each category.

After returning to San Francisco, analysis server 150 may process the transaction records 208 to determine that the customer went to the grocery store and a quick service restaurant, as well as a ticket size of each purchase. Analysis server 150 may categorize the transaction records into categories and may generate data on contemporaneous spending 406 for each category and ticket size. As seen in FIG. 4, contemporaneous service spending 406 includes categories of grocery store and quick service restaurant, as well as a total ticket size indicating the amount spend in each category.

In addition to or other than spending categories, analysis server 150 may include or associate other types of service data in the spending profile including, for example, non-purchase data. Non-purchase data may include information on one or more of cancellations, upgrades, where else a customer traveled, length of stay, frequency of stay with service provider merchant, share of bookings, and the like. Other types of purchase data that may be included in the service profile are total amount of money spent at the service provider merchant, total amount spent at other merchants, ticket price, and the like.

Continuing the cruise example, analysis server 150 may generate a spending profile 402 for each customer on the cruise based on their respective account identifiers and the specified filters. It is noted that a spending profile may be generated for any type of service provider, in addition to or other than a cruise line.

In some examples, analysis server 150 may not provide a spending profile 402 on individual customers of a service provider merchant to that merchant to protect customer privacy. Instead of providing a spending profile 402 on an individual customer, the data provided will preferably be aggregated so as to obscure the spending of any particular customer. In particular, analysis server 150 may aggregate spending profiles to generate an aggregate spending profile 402 for a merchant's customers. Aggregation may also be used to obtain insight into purchasing behavior of the merchant's customers as a group. Some individual customers may, however, at their sole option opt-in and authorize the analysis server to provide their spending profile 402 to one or more merchants. Some of the customers may choose to opt-in, in exchange for an incentive.

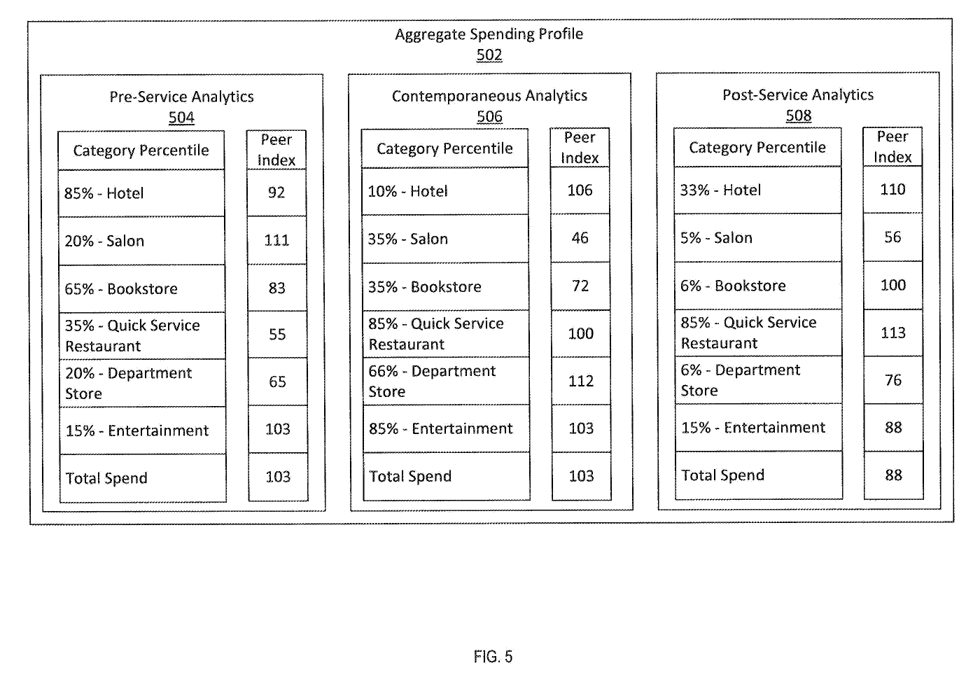

FIG. 5 illustrates an aggregate spending profile in accordance with example embodiments. The aggregate spending profile 502 may identify pre-service analytics 504, contemporaneous analytics 506, and post-service analytics 508. Within analytics 504, 506, and 508, analysis server 150 may also identify percentiles of customers that made purchases within particular categories and identify a peer index for each category.

Pre-service spending 504 may identify metrics of a service provider merchant's customers for purchases made during the time period occurring before the service date. The pre-service spending 504 may include all purchases made on the service date prior to the time on the service date the service is scheduled to be provided. Contemporaneous analytics 506 may identify metrics for a service provider merchant's customers on purchases made while the service is being provided. Post-service analytics 508 may identify metrics for a service provider merchant's customers on purchases made after the service has been provided.

Continuing the cruise example from above, analysis server 150 may determine what percentage of the service provider's customers made purchases from other merchants in one or more categories prior to, contemporaneously with, or after the service date. The example in FIG. 5 illustrates a hotel category, a salon category, a bookstore category, a quick service restaurant category, a department store category, an entertainment category, and a total spend. A category may be included in the aggregate spending profile 502 based on a percentage of the merchant's customers making a purchase within that category exceeding a threshold. Alternatively or additionally, a merchant user may specify categories of interest for inclusion in the aggregate spending profile 502.

In the example depicted in FIG. 5, pre-service analytics 504 may indicate that 85% of the merchant's customers stayed at a hotel, 66% went to a salon, 65% went to a bookstore, and so forth. Under contemporaneous analytics 506, 10% of the merchant's customers stayed at a hotel, 35% went to a salon, 35% went to a bookstore, and so forth. Under post-service analytics 508, 33% of the merchant's customers stayed at a hotel, 5% went to a salon, 6% went to a bookstore, and so forth.

Analysis server 150 may also generate a peer index to compare how a service provider merchant's customers compare to customers of other peer group merchants. For example, analysis server 150 may compare aggregated data on customers of one cruise line to aggregated data of a peer cruise line's customers. Analysis server 150 may determine a value for a peer index by dividing the particular merchant's customer percentage for the category by the average customer percentage of peer merchants, and multiplying the result by 100. In an example, a category percentile customers of a service provider merchant who also purchase salon services may be 20% and 18% on average for peer group merchants. A peer index may be 111 (e.g., 0.2/0.18*100=111). Analysis server 150 may identify other types of peer indices, such as a peer an index based on one or more of average ticket size in a particular category or average total spend in two or more categories, by geographic location, by sales channel (e.g., online, in-store, etc.), share of spend in the industry relative to peers, and the like.

In some examples, if the peer group contains only one or a few merchants, analysis server 150 may decline to provide a merchant with the aggregated spending profile 502 to prevent one merchant from obtaining specific data on a competitor, absent both competitors agreeing to share this data with one another.

Analysis server 150 may aggregate other types of service data in the aggregate spending profile including, for example, non-purchase data. Non-purchase data may include information on one or more of cancellations, upgrades, where else a customer traveled, length of stay, frequency of stay with service provider merchant, share of bookings, and the like.

A service provider merchant may use the aggregate data from the spending profile 402 and/or the aggregate spending profile 502 to gain insight into behavior of their customers, to make business decisions, and to form business relationships. For example, an airline may learn that at least a certain percentage of their customers park in a short-term airport parking lot on trips lasting over two weeks. This information may lead the airline to provide a parking voucher to offset a portion of the parking cost and that offer may perhaps be tied to the user's agreement to upgrade to a first class ticket. One service provider merchant may also form a partnership with another merchant. For example, a hotel merchant may learn that at least a certain percentage of their customers fly in from a different city and stay at a competitor hotel the night before a flight. The hotel merchant may offer a discount to have the customer stay with an affiliate hotel the night before the flight in an attempt to capture additional business from the customer.

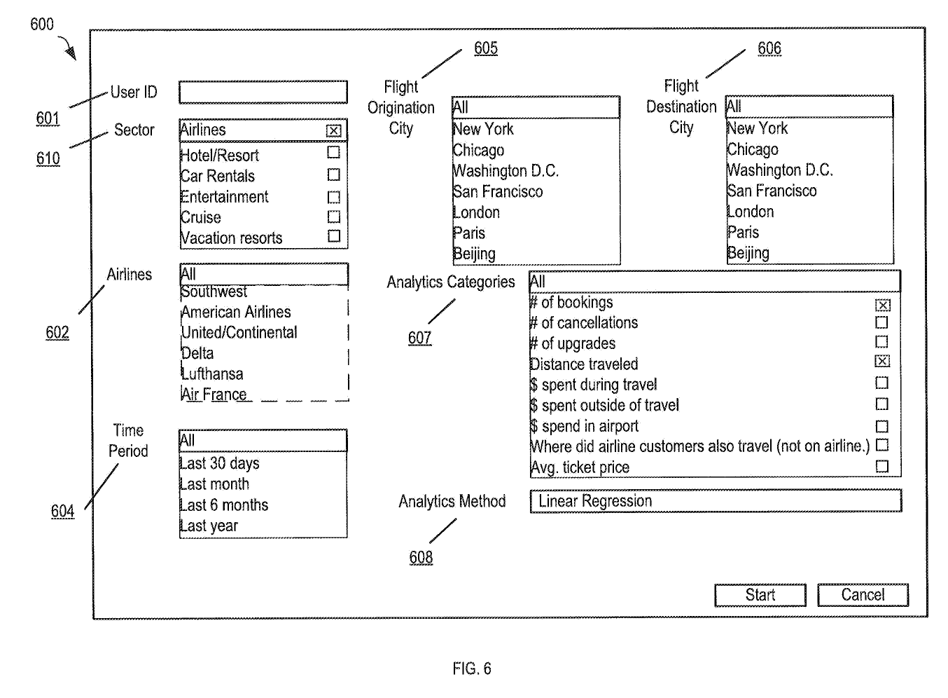

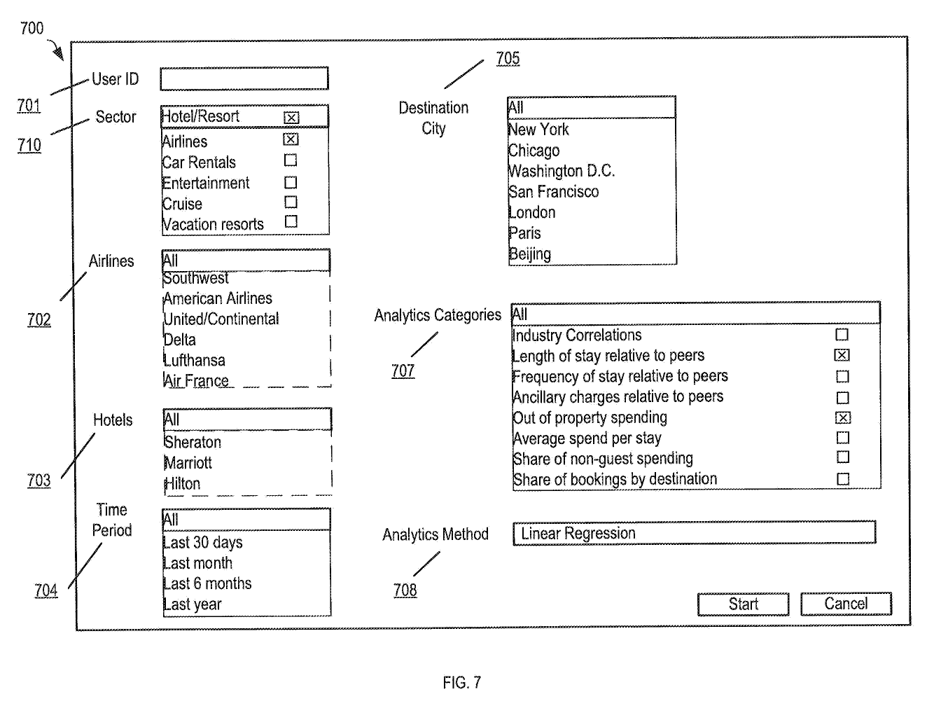

In some embodiments, analysis server 150 may provide a graphical user interface permitting merchants to request certain types of aggregated data to learn about their customers and about their performance relative to peer merchants. FIGS. 6 and 7 depict example aspects of a graphical user interfaces (GUI) 600 and 700 in accordance with example embodiments. FIG. 6 provides an example relating to the airline industry, and FIG. 7 provides an example relating to the hotel industry and the airline industry.

A merchant user may use their merchant terminal 55 to request GUI 600 from analysis server 150 (or other webserver). GUI 600 may prompt the merchant user for authentication information such as, for example, a User ID 601 and password information. The user may select a sector of interest (e.g., airlines, hotels/resorts, car rentals, entertainment, cruise lines, vacation resorts, and/or the like) on which to obtain analytics data. In the example depicted in FIG. 6, GUI 600 may prompt selection of one or more sectors in field 610 for generation of analytics data Example sectors include hotels, car rentals, entertainment, cruises, sports venues, theaters, vacation resorts, and the like. As seen in FIG. 6, a checkbox for an airline in field 610 is selected. In other embodiments, multiple sectors may be selected.

In field 602, the user may select one or multiple airline carriers 102 for analysis. Airline carriers may be selected from a drop-down box (e.g., all airline carriers, Southwest, American Airlines, United/Continental; Delta, Lufthansa, Air France, and/or the like). In another example, if a hotel is selected in field 610, field 602 may include a hotel drop down selection box including hotels such as, for example, Sheraton, Marriott, Hilton, Four Seasons, Hyatt, and/or the like. In alternative or additional embodiments, GUI 600 may be configured to permit a single merchant (e.g., one airline company, and/or one hotel) to obtain aggregated data on their customers. For example, field 602 may list the merchant's name so they may obtain their own aggregated data. In other alternative or additional embodiments, analytics may only be provided in such a manner as to avoid revealing the underlining merchants. In some examples, the merchant user may also select a flight origination city in field 605 and/or a flight destination city in field 606. The user may select in field 604 a period of time for analysis (e.g., all historical data, last thirty days, last month, last six months, last year, and/or the like).

In field 607, a merchant user may specify what categories of analytics data are to be analyzed (e.g., average ticket, sales trends (e.g., day to day, week over week, month over month, year over year sales data, etc.), visit frequency, disputes, fraud, other merchants, number of bookings, number of cancellations, number of upgrades, distance traveled, amount of money spent during travel and/or outside of travel, amount of money spent in the airport, where did airline customers also travel (not on airline), average ticket prices, and/or the like. In some embodiments, the merchant user may select one or more types of the analytics categories in field 607. The user may select in field 608 which analytics method is to process the data (e.g., linear regression, logistic regression, and/or the like).

In addition to or besides the ones shown in field 607, there are many different categories of data that can be analyzed. Examples of analytics categories include: share of dollars and/or numbers by origination; share of dollars and/or numbers by destination; number of bookings per household relative to competition; distance traveled to airport by origination point; category spend breakdown of customers (during and/or outside travel) and how it's compared to peers; category spend breakdown of customers broken down by Metropolitan Statistical Area (“MSA”) and/or other geographic grouping; affluent customer analysis (e.g., number of bookings, average ticket price relative to peer); average spend for customer in trip relative to peers, affluent versus other economic groups; flight lead time for booking and comparison to peers (e.g., comparison of ticket prices by bands of days); in-flight charge analysis; ancillary ground services analysis (e.g., baggage, cargo, upgrades, etc.), timing, frequency, average amounts; cancellation analysis; missed opportunities/identification of opportunities for sale of distressed inventory by route; using real time triggering capability to book distressed inventory; link co-brand customer data to rewards program; identify populations of similar behavior to co-brand customer in non-co-brand population; analysis of reservation abandonments resulting in alternate carrier booking; other online purchases categories for customers booking online with southwest; provide targeting for where to place ads online; category spending by destination (e.g.; in Vegas, shoppers v. show goers v. gamblers); use tracking of transactional data to initiate reward or other action; travel seasonality by destination and origination, leisure versus corporate; U.S. versus international; propensity models; likelihood to travel; indices demonstrating historical spend in airline travel (e.g., by zip plus four or other aggregator including overlays of demo/social/behavioral); airport site selection: identification if underserved geographies where they should place planes; MSA level economic data to provide health indicator; understanding how economic conditions fit into facility location decision; where did airline customers also travel; not on airline; share of wallet by destination; transactions in airport: food, parking, purchases; time of day, day of week peak travel times, time of day, day of week booking times; where travelers are booking from; tourists versus commercial travelers; event analysis (e.g., Super Bowl, Olympics); correlation between airlines and hotels (e.g., where do they stay before flight to identify potential non-channel partners); correlation with current partners; advertisement measurement (e.g., use of data to measure effectiveness of advertising) including digital advertisements and advertisements in physical locations (e.g. billboards, buses) effectiveness based on spend trend of customers physically located in proximity of physical advertisements; analysis of various travel channels; impact of gasoline prices on customer propensity to travel (e.g., channel shift); impact on other economic factors (e.g., propensity to travel, channel shift); international customers using domestic carriers for domestic legs (e.g., what countries are they coming from, and/or which carriers they are coming from); traveler dispersion (e.g., how far travel upon destination; economic zone around destination); co-brand overlay of all; operations/fraud; charge backs, fraud relative to competitors; and/or the like. Based on the selections received in FIG. 6, the analysis server 150 may generate an aggregated spending profile to display one or more of pre-service analytics 504, contemporary analytics 506, and/or post-service analytics 508 that include data on the analytics categories selected in field 607.

FIG. 7 illustrates example aspects of a graphical user interface (700) for hotel and/or airline analytics in accordance with example embodiments. In some examples, a merchant user may provide authentication information in field 701 such as, for example, User ID and password information. In field 710, the user may select one or more sectors (e.g., airlines, hotels/resorts, car rentals, entertainment, cruise lines, vacation resorts, and/or the like) for analysis. In this example, both the hotel/resort sector and airline sectors are selected. In other embodiments, a single sector may be selected or two or more sectors may be selected. In response to selection of a particular sector, GUI 700 may present a field listing one or more merchants in the selected sector (e.g., allowing views of industry correlations 207). For example, field 702 may present a drop-down box listing multiple airline carriers (e.g., all airline carriers, Southwest, American Airlines, United/Continental; Delta, Lufthansa, Air France, and/or the like) available for analysis. Field 703 may present a drop-down box listing multiple hotels (e.g., all hotels, Sheraton, Marriott, Hilton, and/or the like) available for analysis. In field 704, the user may select a period of time for analysis (e.g., all historical data, last thirty days, last month, last six months, last year, and/or the like).

In some embodiments, the user may select in field 705 a hotel destination city. In field 707, GUI 700 may prompt the user to select analytics categories of interest (e.g., length of stay relative to peers; frequency of stay relative to peers; ancillary charges relative to peers; out of property spending; average spend per stay; share of non-guest spending; share of bookings by destination; and/or the like). In field 708, the user may select which analytics method is to be used for data analysis (e.g., linear regression, logistic regression, and/or the like).

In addition to or besides the ones shown in field 707, there are many different categories of data that can be analyzed. Examples of analytics categories include: length of stay relative to peers/class; frequency of stay relative to peers/class; analysis of ancillary charges relative to peers/class; out of property spending (e.g., share of trip, time component, etc.); average spend per stay versus competition; share of non-guest spending; share of bookings by destination; share of destination spend; analysis of non-room spend by room rate; share of hotel/resort spend by origination geo, origination and destination geographic combo (e.g.; share of stays New York travel to Florida); targeting of customers for ancillary services based on non-trip and prior trip behavior (e.g.; personal care, on property/in room dining); targeting/signaling of booked customers for interest in onsite shopping/dining outlets; business and personal coming together; potential offers impact; analysis of average ticket based on days from booking to stay for destination and class of hotel; travel propensity scores (e.g., likelihood of individual to travel); share of overall hotel/resort spend by geography (e.g., geography of hotel); share of overall hotel/resort spend by demography/geography (e.g., geography of customer); event triggers (e.g., airline booking, arrival (in geography), gone offsite, etc.); planning and/or booking sequencing; outside of travel spend behavior, identification of partner opportunities (e.g., business services. retail, complementary travel (e.g. correlation of guests and affinity to specific rental car agencies); average spend in the categories outside of trip (e.g.; restaurant); analysis to support site selection; conference/meeting spend versus peers; share of corporate versus personal spend; dollar band analysis; destination sequencing; type of transportation to destination analysis; share of wallet spend (e.g., how much spent at one merchant as compared to peer group); share of weekday versus weekend purchases; local property usage; distance to property analysis; type of spend during visit/overlays of other lifestyle/interest data; share of bookings for travel facilitators/consolidators (e.g. tour companies); source of reservation; timeshare analysis; country of origin reporting; and/or the like. Based on the selections received in FIG. 7, the analysis server 150 may generate an aggregated spending profile to display one or more of pre-service analytics 504, contemporary analytics 506, and/or post-service analytics 508 that include data on the analytics categories selected in field 707.

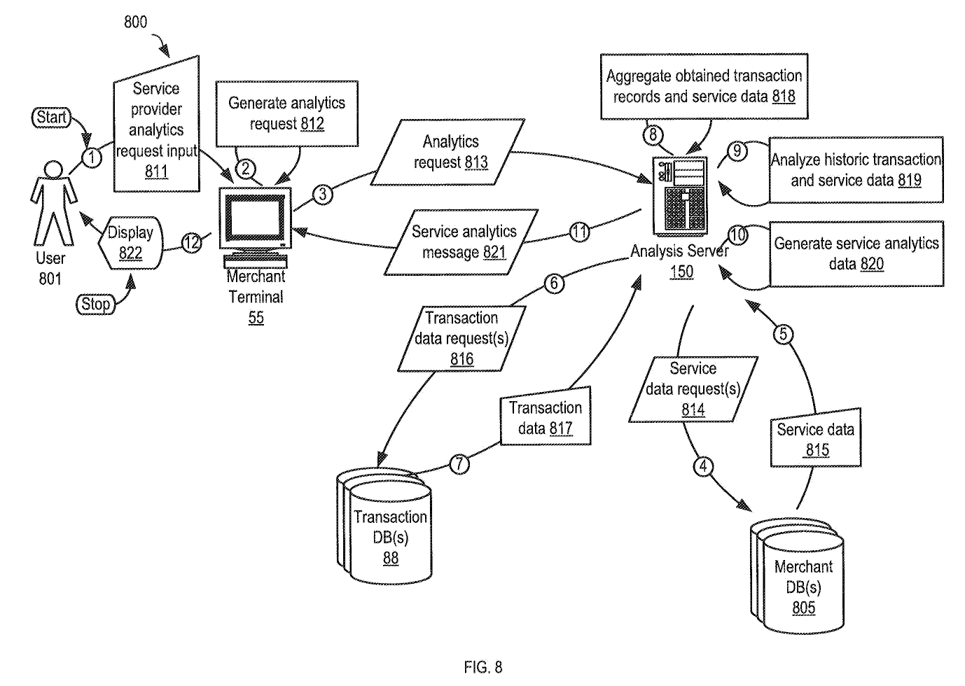

FIG. 8 illustrates example aspects of obtaining service provider analytics in accordance with example embodiments. In some examples, a merchant user 801 may request a service provider analytics report. The user may use merchant terminal 55 to communicate with analytics server 150 to request GUI 600 or 700. For example, the user may direct a browser application executing on merchant terminal 55 to a website of the analysis server 150.

In some implementations, merchant terminal 55 may generate an analytics request message including the input received from the user in GUI 600 or GUI 700. For example, a browser application executing on the client may provide, on behalf of the user, a (Secure) Hypertext Transfer Protocol (“HTTP(S)”) GET message including the analytics request details in the form of data formatted according to the eXtensible Markup Language (“XML”). Below is an example HTTP(S) GET message including an XML-formatted analytics request message 813 for analysis server 150:

GET /analytics.php HTTP/1.1
Host: www.TTIA.com
Content-Type: Application/XML
Content-Length: 1306
<?XML version = “1.0” encoding = “UTF-8”?>
<analytics_request>

<request_ID>4NFU4RG94</order_ID>
<timestamp>2011-02-22 15:22:43</timestamp>
<user_ID>john.q.public@gmail.com</user_ID>
<analytics_details>

<airlines>Southwest</airlines>
<hotels>Hilton</hotels>
<flight_origination>NewYorkCity</flight_origination>
<flight_destination>sanFrancisco</flight_destination>
<analytics_period>from 2010-03-01 0:0:0 to 2010-03-31
23:59:59

</flight_origination >

<analytics_type>$ spent during travel</analytics_type>
<analytics_algorithm>linear regression </analytics_algorithm>

</analytics_request >

In response to the analytics request message, analysis server 150 may generate a data request 814 to retrieve service data from database(s) 805 of the merchant. The database(s) may be managed by the merchant (e.g., airline carriers, hotels/resorts, car rental companies, and/or the like) and include data on services provided to merchant customers. Customer's service data 815 (e.g., account identifier, customer ID, airline carrier, flight take off time, flight land time, and/or the like) may be sent to analysis server 150. Analysis server 150 may also send a transaction data request 816 to the transactions database(s) 88, which may be managed by the payment network companies. The transactions database(s) may provide transaction records 208 to analysis server 150 in response to the transaction data request. In other examples, transaction records 208 and the service data may be stored in a single database.

In an embodiment, analysis server 150 may generate several tables for storage in a database based on the collected data. These tables may include a user table, a merchant table, an analysis request table, a transaction table, an analysis report table, and a sector table. The user table may include fields such as, but not limited to: user_id, user_password, user_employer, user_contact_info, and/or the like. The user table may support and/or track multiple accounts for a customer. The merchant table may include fields such as, but not limited to: merchant_ID, merchant type, merchant_name, merchant_address, merchant_contact_info, merchant_customer_ID, merchant_customer_product_type, merchantcustomer_product_info, and/or the like. The analysis request table may include fields such as, but not limited to: request_id, user_id, merchant_id, analysis_type, analysis_method, analysis_output_type, analysis_time_period, and/or the like. The transaction table may include fields such as, but not limited to: order_id, customer_id, timestamp, transaction_cost, purchase_details_list, num_products, products_list, product_type, product_params_list, product_title, product_summary, quantity, account_firstname, account_lastname, account_type, account_num, billingaddress_line1, billingaddress_line2, billing_zipcode, billing_state, shipping_preferences, shippingaddress_line1, shippingaddress_line2, shipping_zipcode, shipping_state, merchant_id, merchant_name, and/or the like. The analysis report table may include fields such as, but not limited to: report_id, user_id, request_id, merchant_id, report_output_type, report_details, and/or the like. The sector table may include fields such as, but not limited to: sector_ID, merchant_ID, analysis_output_type, and/or the like.

In some implementations, analysis server 150 may aggregate the obtained transaction records and service data. The aggregation may be based on the type of analytics specified in the analytics request 813. In some implementations, based on the user-selected analytics method (e.g., linear regression, and/or the like), analysis server 150 may analyze the obtained data to generate a service provider analytics data 820. Analysis server 150 may generate a service analytics message 821 including the generated analytics data for communication to merchant terminal 55 for presentation of the analytics data to the merchant user 822 in, for example, spending profile 402 or aggregated spending profile 502

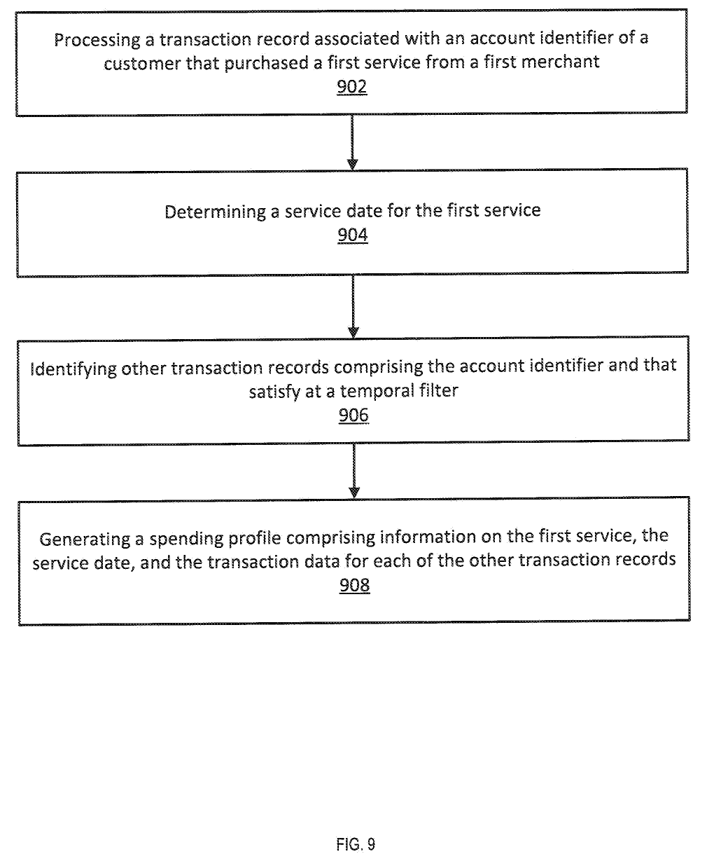

FIG. 9 illustrates a flow chart of a method for service provider analytics in accordance with example embodiments. The flow diagram may be implemented by a system or apparatus, such as, for example, analysis server 150. Each of the blocks shown in the flow diagram may be repeated one or more times, one or more of the blocks may be modified, and one or more of the blocks may be omitted. The method may be stored on a non-transitory computer readable medium as computer executable instructions. The computer executable instructions, when executed by at least one processor, may cause at least one computer or other device to perform the blocks as steps of a method one or more times. The flow diagram may begin at block 902.

In block 902, the method may include processing a transaction record associated with an account identifier of a customer that purchased a first service from a first merchant. In an example, a user may present their credit card having an account identifier to a merchant (e.g., online or in-store) to purchase a service. A merchant terminal 55 may communicate a transaction request to a payment network server 102 for determining whether to approve or decline payment. The payment network server 102 may also create and store a transaction record 208 in transaction database 88 that includes transaction data (e.g., account identifier, transaction date, etc.) obtained from the payment transaction request. The transaction record 208 may also include service data indicating a date in which a service is to be performed or was performed. The payment network server 102 and/or analytic server 150 may also query the merchant terminal 55 or merchant server 82 for the service data. When generating analytics, the analysis server 150 may process the transaction record 208.

In block 904, the method may include determining a service date for the first service. In an example, analysis server 150 may process service data included in the transaction record 208 to obtain the service date. In another example, analysis server 150 may obtain the service date from the merchant terminal 55 or merchant server 82.

In block 906, the method may include identifying, by a processor, other transaction records comprising the account identifier and that satisfy a temporal filter. In an example, analysis server 150 may query the transaction database to obtain other transaction that include transaction data associated with at least one of: (1) purchase of another service to be provided within a first predetermined amount of time of the service date, and (2) purchase of a product within a second predetermined amount of time of the service date. Geographic and/or temporal filters may also be used to filter the transaction records.

In block 908, the method may include generating a spending profile based on information on the first service, the service date, and the transaction data for each of the other transaction records. In an example, analysis server 150 may generate a spending profile, an example of which is shown in FIG. 4 and described above. In another example, analysis server 150 may generate an aggregated spending profile, an example of which is shown in FIG. 5 and described above.

The method in FIG. 9 may end, may repeat one or more times, or may return to any of the preceding blocks.

The various participants and elements described herein may operate one or more computer apparatuses to facilitate the functions described herein. Any of the elements in the above-described Figures, including any servers, user terminals, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, system 100 and the methods described herein may be configured to provide customer insight and to compare merchant performance to their peer group. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

1. A method comprising:
processing, by a processor, a transaction record associated with an account identifier of a customer that purchased a first service from a first merchant;
determining a service date for the first service;
identifying, by the processor, other transaction records comprising the account identifier and that satisfy a temporal filter, wherein each of the other transaction records comprises transaction data associated with at least one of: (1) purchase of another service to be provided within a first predetermined amount of time of the service date, and (2) purchase of a product within a second predetermined amount of time of the service date; and
generating, by the processor, a spending profile comprising information on the first service, the service date, and the transaction data for each of the other transaction records.

2. The method of claim 1, further comprising:
generating an aggregate profile by aggregating data from a first category in the spending profile with data from the first category in the other spending profiles.

3. The method of claim 2, wherein the generating of the aggregate profile comprises aggregating data from a first category in the spending profile with data from the first category in the other spending profiles.

4. The method of claim 2, further comprising:
identifying a group of merchants that are peers to the merchant; and
generating an aggregate peer group profile for the peer group merchants.

5. The method of claim 4, further comprising:
generating a peer index by comparing the aggregate profile to the aggregate peer group profiles.

6. The method of claim 5, wherein the generating of the peer index comprises generating a comparison of a percentage of the merchant's customers who make a purchase within a category relative to a percentage of peer group merchant's customers who made a purchase within the category.

7. The method of claim 5, wherein the generating of the peer index comprises generating a comparison of an average ticket size of the merchant's customers who make a purchase within a category relative to an average ticket size of peer group merchant's customers who made a purchase within the category.

8. A non-transitory computer readable medium storing instructions that, when executed, cause an apparatus at least to perform:
processing a transaction record associated with an account identifier of a customer that purchased a first service from a first merchant;
determining a service date for the first service;
identifying other transaction records comprising the account identifier and that satisfy a temporal filter, wherein each of the other transaction records comprises transaction data associated with at least one of: (1) purchase of another service to be provided within a first predetermined amount of time of the service date, and (2) purchase of a product within a second predetermined amount of time of the service date; and
generating a spending profile comprising information on the first service, the service date, and the transaction data for each of the other transaction records.

9. The computer readable medium of claim 8, wherein the instructions, when executed, further cause the apparatus to generate an aggregate profile by aggregating data from a first category in the spending profile with data from the first category in the other spending profiles.

10. The computer readable medium of claim 8, wherein the instructions, when executed, further cause the apparatus to generate an aggregate profile by aggregating non-purchase data in the spending profile with non-purchase data in other spending profiles.

11. The computer readable medium of claim 10, further comprising:
identifying a group of merchants that are peers to the merchant; and
generating an aggregate peer group profile for the peer group merchants.

12. The computer readable medium of claim 11, further comprising:
generating a peer index by comparing the aggregate profile to the aggregate peer group profiles.

13. The computer readable medium of claim 12, wherein the generating of the peer index comprises generating a comparison of a percentage of the merchant's customers who make a purchase within a category relative to a percentage of peer group merchant's customers who made a purchase within the category.

14. The computer readable medium of claim 11, wherein the generating of the peer index comprises generating a comparison of an average ticket size of the merchant's customers who make a purchase within a category relative to an average ticket size of peer group merchant's customers who made a purchase within the category.

15. An apparatus comprising:
at least one processor; and
at least one memory storing computer readable instructions that, when executed by the at least one processor, cause the apparatus at least to perform:
processing a transaction record associated with an account identifier of a customer that purchased a first service from a first merchant;
determining a service date for the first service;
identifying other transaction records comprising the account identifier and that satisfy a temporal filter, wherein each of the other transaction records comprises transaction data associated with at least one of: (1) purchase of another service to be provided within a first predetermined amount of time of the service date, and (2) purchase of a product within a second predetermined amount of time of the service date; and
generating a spending profile comprising information on the first service, the service date, and the transaction data for each of the other transaction records.

16. The apparatus of claim 15, wherein the instructions, when executed, farther cause the apparatus to generate an aggregate profile by aggregating data from a first category in the spending profile with data from the first category in the other spending profiles.

17. The apparatus of claim 15, wherein the instructions, when executed, further cause the apparatus to generate an aggregate profile by aggregating non-purchase data in the spending profile with non-purchase data in the other spending profiles.

18. The apparatus of claim 17, further comprising:
identifying a group of merchants that are peers to the merchant; and
generating an aggregate peer group profile for the peer group merchants.

19. The apparatus of claim 15, wherein the instructions, when executed, further cause the apparatus to generate a peer index by comparing the aggregate profile to the aggregate peer group profiles based on a comparison of a percentage of the merchant's customers who make a purchase within a category relative to a percentage of peer group merchant's customers who made a purchase within the category.

20. The apparatus of claim 15, wherein the instructions, when executed, further cause the apparatus to generate a peer index by comparing the aggregate profile to the aggregate peer group profiles based on a comparison of an average ticket size of the merchant's customers who make a purchase within a category relative to an average ticket size of peer group merchant's customers who made a purchase within the category.
